(19) United States
(12) Patent Application Publication
(10) Pub. No.: US 2022/0289095 A1
(43) Pub. Date: Sep. 15, 2022

(54) Frontloading Enclosure utilizing Both a Primary Magnetic Connection System and a Secondary Constant-tension Resistance System.

(71) Applicant: Craig Schreiber, Las Vegas, NV (US)

(72) Inventor: Craig Schreiber, Las Vegas, NV (US)

(21) Appl. No.: 17/198,193

(22) Filed: Mar. 10, 2021

(51) Int. Cl. B60P 1/64; A47B 95/00

(52) U.S. Cl. CPC B60P 1/6409; B60P 1/6418; A47B 95/008

(57) ABSTRACT

A frontloading serviceable enclosure using both a primary magnetics-based connection system backed up by a secondary connection system utilizing a Constant-tension spring-like resistance Subsystem whereby resistance system provides a mechanism that when the primary magnetic connection system is dislodged and disrupts the primary connection of the magnetic system, the secondary constant-tension resistance subsystem provides the necessary mechanism which maintains and/or repositions the dislodged front modules from the enclosure whereby the primary magnetic system is re-engaged between the front loaded module and the enclosure.

The secondary constant-tension resistance subsystem provides the necessary backup connection system, and more importantly, it is designed to re-engage the primary magnetic connection when the magnetic holding system is dislodged for any reasons

### BACKGROUND OF THE INVENTION

The present invention is in the field of frontloading enclosures where replaceable modules are affixed to the enclosures using a methodology that keeps them connected and in place and not dislodged due to vibration or other reasons where the front modules can be dislodged from the enclosures and the secondary constant-tension resistance subsystem keeps the modules in place and reengages the primary connection system

Back-sided serviceable enclosures have been around for a long time, but they present a real problem compared to frontloading enclosures when it comes to serviceability when attached to a wall or to the side of a truck.

Current frontloading enclosure systems use magnets, but magnets can be dislodged due to vibration and other reasons. When a magnetic connection system is dislodged due to vibration, the frontloading module will be displaced and become unattached from the enclosure. Other system using small set-screw subsystems have been used, but this approached cannot be utilized when the frontloaded module functionality is compromised due to the physical size and requirements related to the use of even the smallest set-screw system.

Other frontloading connection systems use Bluetooth or Wi-Fi connections with an attached hinge to open up the front module, but these can be problematic and rely on a network system.

The use of a constant-tension resistance subsystem like our Bungee Cord Subsystem provides both a secondary safety connection system (when a frontloading module can become dislodged by vibration or for whatever reason), and it also provides the mechanism to realign the frontloading module back in place whereby establishing the primary connection provided by the magnets

### SUMMARY OF THE INVENTION

The present invention utilizes a 3D printed carbon-fiber based frontloading enclosure utilizing both a primary magnetic connection system and a secondary constant-tension resistance subsystem.

A constant-tension resistance subsystem is the key to maintaining the frontloaded modules attached to the enclosure with magnets from being dislodged and inoperable. Our constant-tension resistance subsystem is attained by using a long bungee cord that is stretched thin by wrapping it around in a circular manner to keep and maintain its constant-tension resistance.

By wrapping the bungee cord in a circular manner in the piping system of our bungee cord subsystem attains and maintain a constant-tension resistance in the cord that is then attached to the frontloading module via the bracket that is fused to the frontloading module utilizing a locking system that is secure but also easily removed by hand when the frontloading module is dislodged from the enclosure utilizing a handheld vacuum tool or a magnetic based hand tool.

With a frontloading module dislodged from the enclosure utilizing one of the handheld detaching tools, the operator can easily twist the interlocking connection of the bungee cord from the frontloading module allowing it to be fixed or replaced with a new module.

### SPECIFICATION

The present invention is in the technical field of frontloading Serviceable Enclosures using a primary magnetic holding system with a secondary tethering system using a constant-tension resistance subsystem such that, if the primary magnetic system dislodges for any reason, the secondary tethering system is designed to re-engage the primary magnetic holding system.

Utilizing a 3D printing, carbon-fiber material, and a web-catacomb design process along with our constant-tension resistance subsystem, we are able to produce thin lightweight frontloading enclosures that can be attached to standard stucco and sheetrock walls without having to be reinforced to meet weight-load permit requirements.

Also due to the lightweight and our secure secondary constant-tension resistance subsystem, our frontloading enclosures can be attached to mobile vehicles and/or trailers without having to modify the vehicle or trailer structure. Given the thin, lightweight carbon-fiber frontloading enclosures and by putting the power supply on top, we can attach a mesh of enclosures making one large frontloading display sign onto containers without having to modify the container.

The current Frontloading Serviceable Enclosure is comprised of four (4) quadrants. but it could be comprised of more or less partitioned spaces within the enclosure. Each partitioned area in the enclosure is designed to hold one frontloaded serviceable module.

Each partitioned area of the enclosure comprises of magnets at each corner of the partitioned area as well as the center of the partitioned areas forming the primary connection system for the frontloading serviceable module.

In addition to the magnetic primary connection system, a Secondary Constant-tension resistance subsystem.

For our constant-tension resistance subsystem, we use a long bungee cord whereby we stretch it into a thin cord by wrapping it in a circular matter around a tubular piping subsystem that attains a constant-tension resistance system.

The Bungee Cord is connected to the bracket that is fused to the frontloading module utilizing an (easy-to-attach) interlocking clasp attached to the end of the Bungee cord. By passing the end of the bungee cord with its interlocking clasp through the hole in the fused bracket and then turning it a half turn, the resistance of the constant-tension bungee cord system keeps the bungee cord locked until the service person reverses the process turning the interlocking clasp one-half turn in the opposite direction to release it from the frontloading module.

The constant-tension resistance of our Bungee Cord Subsystem keeps the frontloading module connected to the enclosure at all times until such time that a service person disconnects the frontloading module utilizing a handheld removal tool based on a suction (vacuum) principle or powerful enough magnetic system to dislodge the primary connection magnets.

Utilizing a magnetic connection system only between a frontloading module and the enclosure is unacceptable and not warranted for many reasons. The primary reason that utilizing a magnetic connection only system is not acceptable is that the magnets can be dislodged for a number of reasons creating a safety hazard as well as inoperable system.

Utilizing a constant-tension resistance subsystem provides a secondary connection for safety purposes as well as providing the mechanism to reposition the module(s) back in place whereby the primary connection system is fully engaged.

The constant-tension resistance provided by our Bungee Cord Subsystem sustains a consistent connection whereby maintaining a secure seal between the soft polymer gasket (located on the frontloading module(s)) and the enclosure providing a water resistant seal between the frontloading module(s) and the enclosure.

The use of the Bungee Cord Subsystem does not interfere with the functionality of the frontloading modules found in set-screw connection systems. For example, a frontloading LED enclosure that utilizes a set-screw connection system limits the minimal physical spacing found in high-resolution LED modules. The spacing needed to insert the tool that utilizes a set-screw connection system prohibits using this type of frontloading system on the highest of resolution LED modules. This limitation does not come into play with our Bungee Cord Subsystem.

### BRIEF DESCRIPTION OF THE DRAWINGS

IMPORTANT NOTE: GIVEN THE DETAIL OF THE FRONTLOADING SERVICEABLE ENCLOSURE, THE DEPTH AND DEFINITION PROVIDED BY THE GRAYSCALE OVER STRAIGHT BLACK AND WHITE DRAWINGS IS CRITICAL TO CLEARLY SHOW AND DELINEATE THE SPECIFIC REFERENCES IN THE DRAWINGS

FIG. 1 is a perspective showing the inner detail of the 3D-printed Frontloading LED Enclosure with its sub-systems.

FIG. 2 is a perspective of the use of a web design in the 3D printing of the carbon fiber based enclosure to provide strength while also reducing the weight.

FIG. 3 is a perspective of the enclosure with 3 of the LED modules attached to the enclosure.

FIG. 4 is angle perspective showing the alignment guides (studs) for seamless fitting of multiple enclosures both vertically and horizontally to make one large integrated LED sign.

FIG. 5 is a perspective of the Bungee sub-system that provides the secondary connection system with regard to keeping the LED modules attached and properly aligned for the primary connection system via magnets.

FIG. 6 is a perspective of how the secondary Bungee connection system connects and locks into the LED Modules.

FIG. 7 is a perspective of the Bungee connection system attaching to the fused clamp on the LED Modules to secure connection of the LED Module.

FIG. 8 is a perspective of a closer look at how the Bungee Cord connection system interlocks into the clamp fused on the LED Module so that it is securely locked in and cannot be dislodged.

### DETAILED DESCRIPTION OF THE INVENTION

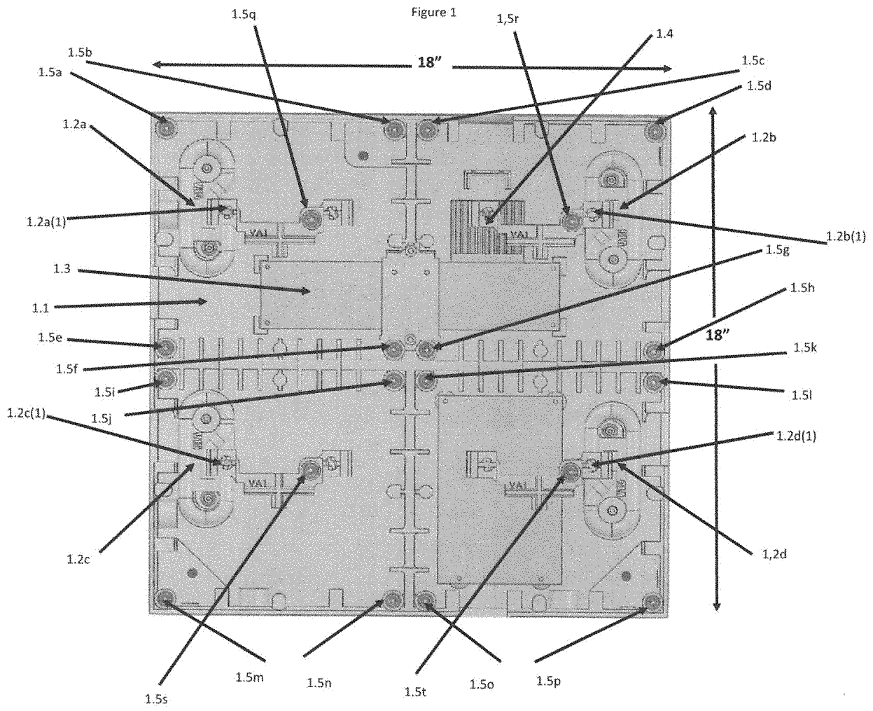

Referring to the invention now in more detail, FIG. 1 shows the inner detail of the 3D printed Enclosure.

As denoted by FIG. 1., this is the 3D printed Enclosure using a carbon fiber filament for strength and light weight.
Ref 1.1 denotes the entire Frontloading enclosure.
Refs 1.2a, 1.2b, 1.2c, 1.2d denotes the Bungee Cord Subsystem. Given there are 4 LED Modules per each enclosure, there are 4 Bungee Cord Subsystems per Enclosure.
Ref 1.2a(1), 1.2b(1), 1.2c(1), 1.2d(1) denotes the Bungee Clasp system that attaches to the LED module(s). As part of the secondary connection system, there is a clasp that is fused to the LED Module that incorporates the Bungee Cord Interlocking system and top center magnet for each LED Module.
Ref 1.3 denotes the low voltage power supply where the power supply in one enclosure can power an additional 3 enclosures for a total of 4 enclosures. (Thus, there is one power supply per every 4 connected enclosure blocks.)
Refs. 1.4 denotes the heat sink to help passively dissipate the heat in conjunction with a small fan that channels the air throughout the enclosure where he heat can dissipate through the LED modules.
Refs. 1.5a, 1.5b, 1.5c, 1.5d, 1.5e, 1.5f, 1.5g, 1.5h, 1.5i, 1.5j, 1.5k, 1.5l, 1.5m, 1.5n, 1.5o, 1.5p denotes the magnetics that is the primary connection system between the enclosure and the LED modules. The connecting magnets are located at the four corners of the 4 corners of the 4 quadrants of the frontloading enclosure.
Refs. 1.5q, 1.5r, 1.5s, and 1.5t denotes the center magnets found in each of the 4 quadrants of the frontloading enclosure.

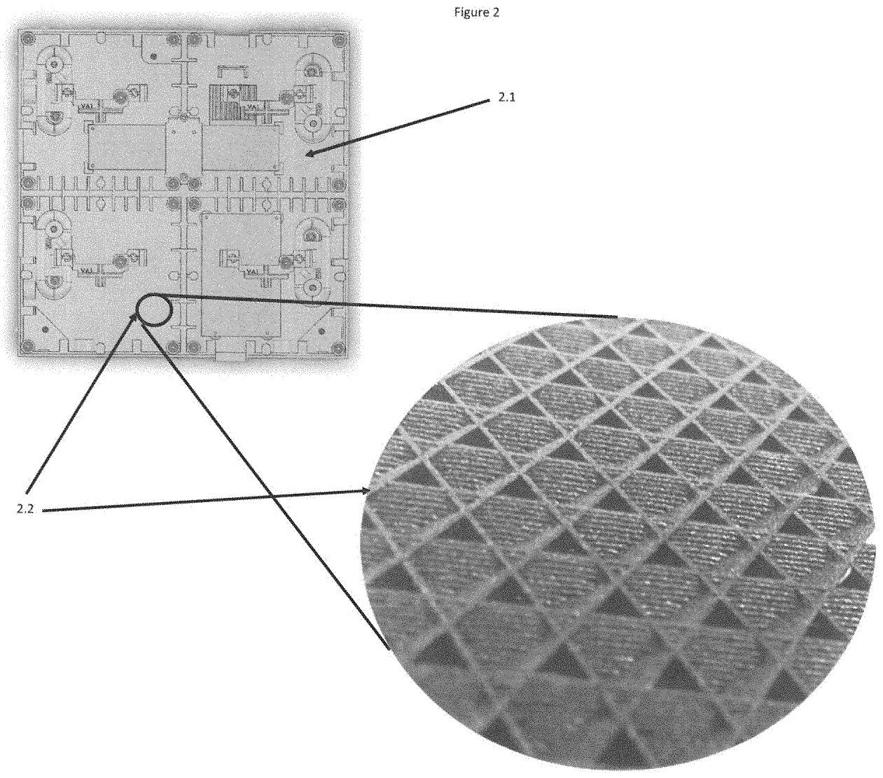

Referring to FIG. 2, Refs 2.1 denotes the total enclosure, and Ref 2.2 denotes an enlarged area of the enclosure showing the web-based design utilized in the 3D printing of the carbon fiber-based frontloading enclosure.

The web-based 3D printing design provides increased of the frontloading enclosure while reducing the weight of the enclosure.

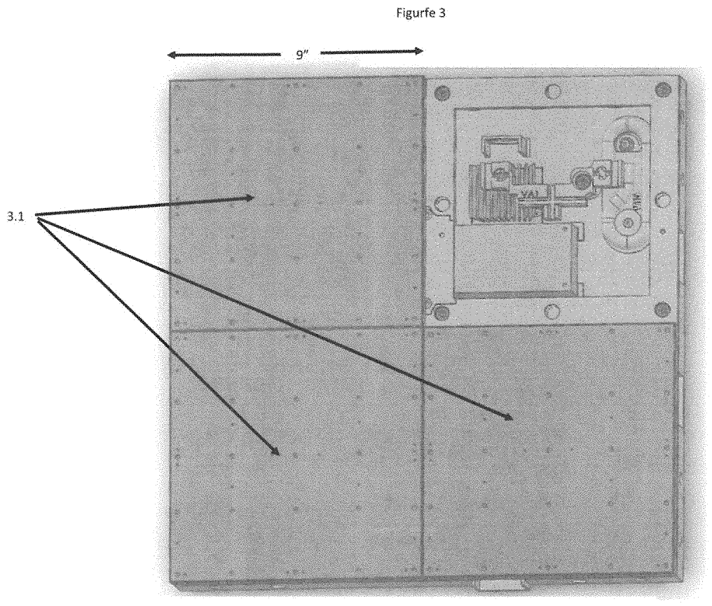

Referring to FIG. 3, Ref 3.1 denotes the LED Modules that are attached to the Enclosure.
Attached to each LED Module is a fused clasp that supports the secondary Bungee Cord connection system as well as center magnet that connects to the center magnet of each of the 4 quadrants within the frontloading enclosure.
Each LED Module has magnets affixed to each corner of the LED Module that corresponds to the like positioned magnets in the 4 corners of each of the quadrants of the frontloading enclosure as part of its primary connection system.

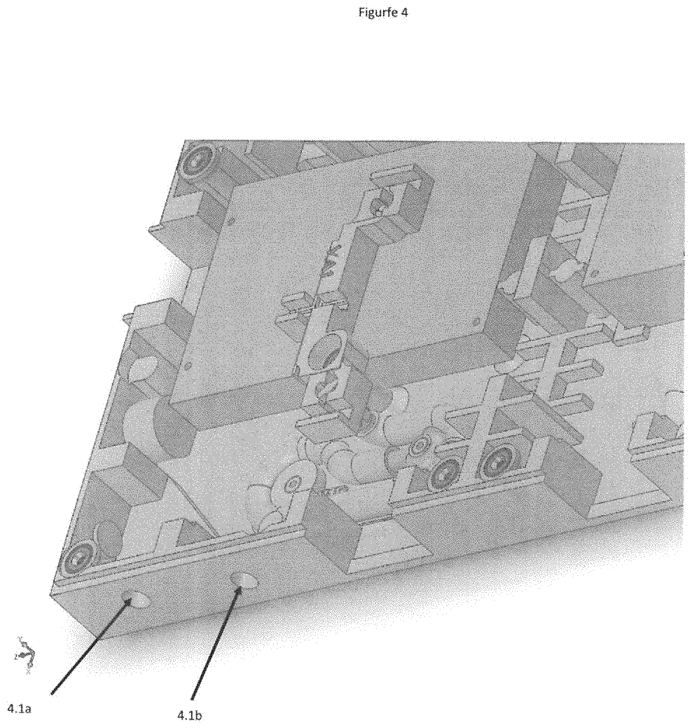

Referring to FIG. 4, Refs 4.1a and 4.1b denotes the alignment points (studs) to provide exact vertical and horizontal alignment of the enclosures for connecting a series of enclosures per the desired size of the LED Sign.

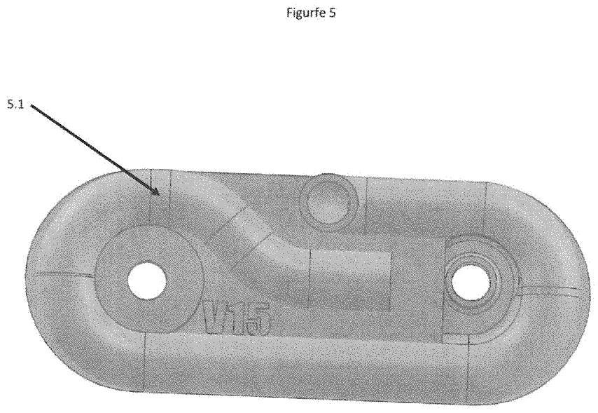

Referring to FIG. 5, Ref 5.1 denotes the Bungee Cord subsystem that utilizes a circular piping system that is used to wrap the bungee cord around in a circular manner to develop the necessary constant spring resistance that is used as a secondary connection system between the LED modules and the Enclosure to insure that when the LED module is dislodged due to vibration from an earthquake or when an enclosure is attached to a moving vehicle that could result or other such manner that may dislodge the primary connection between the LED Module and the frontloading enclosure.
The secondary connection using the constant resistance of the Bungee Cord subsystem provides the necessary tension necessary to re-engage the primary connection system via the magnets on the enclosure and the LED Modules.

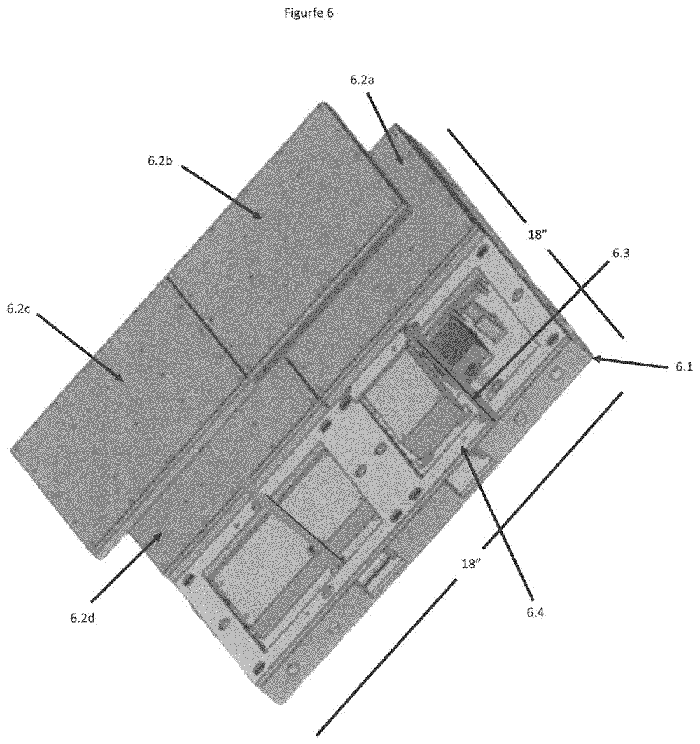

Referring to FIG. 6, Ref. 6.1 denotes the Front Loading Enclosure.
Refs. 6.2a, 6,2b, 6.2c, 6.2d denotes the LED Modules.
Ref 6.3 denotes the Bungee Cord.
Ref 6.4 denotes the Bungee Cord Subsystem.

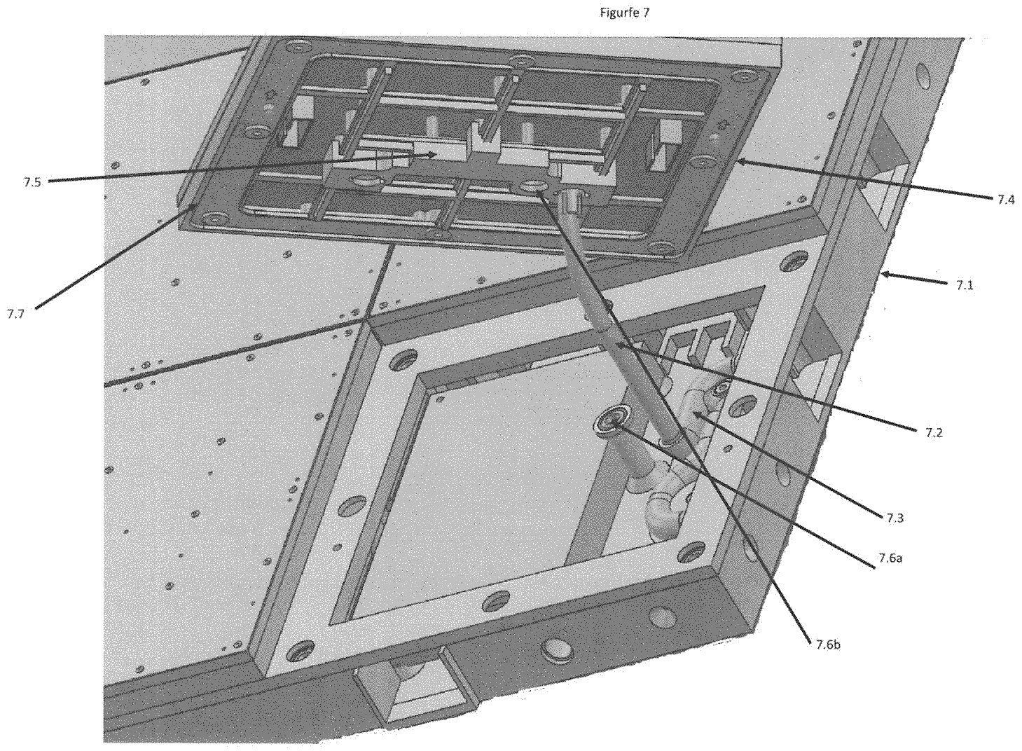

Referring to FIG. 7, Ref. 7.1 denotes the Frontloading Enclosure.
Ref. 7.2 denotes the Bungee Cord.
Ref. 7.3 denotes the Bungee Cord Subsystem.
Ref. 7.4 denotes the LED Module.
Ref. 7.5 denotes the clamp fused to the LED module that provides the interlocking mechanism of the Bungee Cord along with the top magnet.
Ref. 7.6a and 7.6b denote the Enclosure magnet and the LED Module magnet.
Ref 7.7 denotes the soft polymer gasket that resides around the frontloading module to provide a seal when the module is connected to the enclosure.

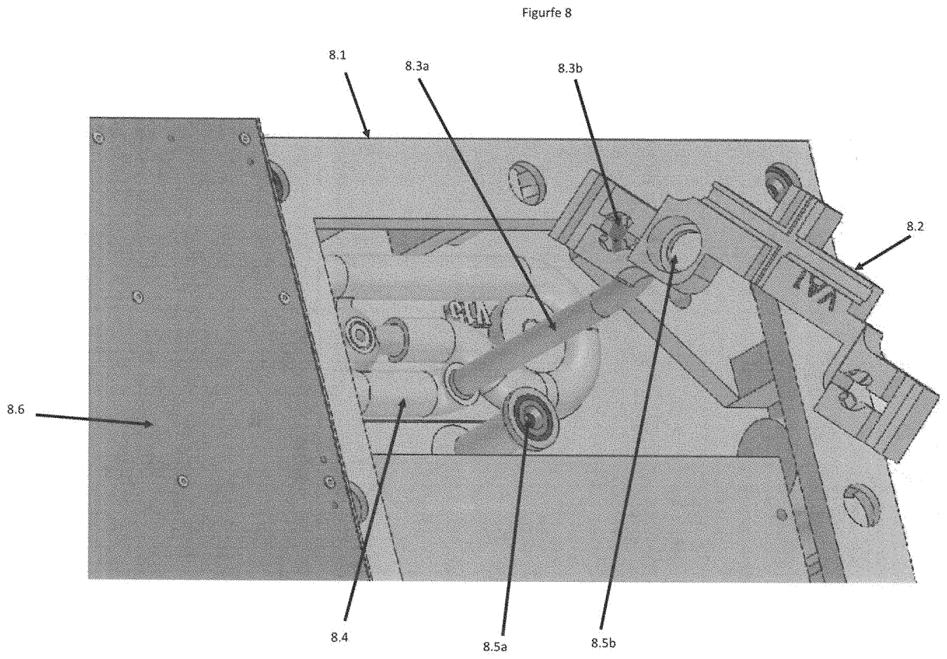

Referring to FIG. 8, Ref. 8.1 denotes the Frontloading Enclosures.
Ref 8.2 denotes the clamp that is fused to the LED Module.
Ref. 8.3a denotes the Bungee Cord, and Ref. 3b denotes the Bungee Cord Interlocking system.
Ref. 8.4 denotes the Bungee Cord Subsystem.
Refs. 8.5a and 8.5b denotes the enclosure and LED module center magnets.
Ref. 8.6 denotes the LED Module.

What is claimed are:

1. A frontloading serviceable enclosures utilizing a constant-tension resistance subsystem as a backup and secondary connection system to a primary magnetic connection system provides a secure backup safety connection and maintains the primary magnetic connection when the magnetic system becomes dislodged for any reason and re-engages the primary magnetic connection system.
a. The use of the constant-tension resistance subsystem provides the necessary resistance between the enclosure and the frontloading module to reposition the module back in place re-engaging the primary magnetic connection system.
b. The long bungee cord stretched circularly using a piping system on the bungee cord subsystem by wrapping the bungee cord in a circular manner creates and maintains the constant-tension resistance of the bungee cord.
c. The constant-tension resistance of our bungee cord subsystem allows the bungee cord subsystem to re-position the frontloading module into the proper position and re-engage the primary magnetic-based connection system.
d. When one or more frontloading modules is dislodged from its primary magnetic system for whatever reason, the secondary connection provided by the bungee cord subsystem maintains the proper position of the frontloaded module, re-engages the primary magnetic connection, and maintains the continuity and functionality related to and provided by the frontloaded module(s)
e. The Bungee Cord Subsystem utilizes an (easy-to-attach) interlocking system between the enclosure and the frontloading modules. By passing the end of the bungee cord with its interlocking clasp through the hole in the fused bracket and then turning it a half turn, the resistance of the constant-tension bungee cord subsystem keeps the bungee cord locked in place.
f. Through the use of a handheld suction-based (vacuum) tool, a person is able to easily remove the frontloading module (that utilizes the bungee cord constant-tension subsystem) from the enclosure allowing the service person to reverse the process of turning the interlocking clasp one-half turn in the opposite direction to release it from the frontloading module allowing the module(s) to be fixed or replaced.
g. The constant-tension resistance provided by our Bungee Cord Subsystem sustains a constant connection whereby maintaining a secure seal between the soft polymer gasket (located on the frontloading module(s)) and the enclosure providing a water resistant seal between the frontloading module and the enclosure.
h. The use of our Bungee Cord Subsystem does not rely on any electronic mechanism utilized in the connection between the frontloaded module(s) and the enclosure making it very easy to maintain the modules.
i. Unlike set-screw connection systems used in some frontloading enclosures, our Bungee Cord Subsystem does not limit or interfere with the functionality of the frontloading module. Set-screw system (regardless of how small they may be) do require the necessary physical spacing to insert the set screw to remove the module.

2. The use of a constant-tension resistance subsystem (like our bungee cord subsystem) as a backup (secondary) connection system to the primary magnetic system incorporated into a carbon-fiber lightweight enclosure allows the enclosures to be affixed to conventional stucco and or sheetrock walls without requiring the walls to be reinforced to meet load wall permit requirements

3. The constant-tension resistance subsystem connection provides the necessary backup (secondary) safety connection to a primary magnetic connection system on a frontloading display enclosure attached to a moving vehicle and/or trailer and ensure the frontloading modules when dislodged due to vibration or any other reason do not fall off and also ensures they re-engage the primary connection system whereby the functionality of the frontloading enclosure is maintained.
a. The interlocking mechanism attaching the constant-tension resistance system between the frontloading serviceable enclosure and the frontloading modules along with the constant-tension resistance of the bungee cord connection keeps the modules from falling off the enclosure and re-engages the frontloading modules with the attached enclosure.
b. The use of a constant-tension resistance subsystem (like our bungee cord subsystem) as a backup (secondary) connection system to the primary magnetic system incorporated into a carbon-fiber lightweight enclosure allows the enclosures to a moving vehicle and/or trailer without having to modify the structure of the vehicle and/or trailer.
c. Given the thin, lightweight carbon-fiber frontloading enclosures and by putting the power supply on top, we can attach a mesh of enclosures making one large frontloading display sign onto containers without having to modify the container.
